(19) United States
(12) Patent Application Publication
(10) Pub. No.: US 2007/0280611 A1
(43) Pub. Date: Dec. 6, 2007

(54) Grooved jacket for undersea cable and method for manufacturing the same

(75) Inventors: Dennis P. Dyer, Pleasant Garden, NC (US); Dean C. Wilson, Greensboro, NC (US); Tatum Boulware, Elon, NC (US); Michael B. Tilley, Kernersville, NC (US)

Correspondence Address: STEPTOE & JOHNSON LLP, 1330 CONNECTICUT AVENUE, N.W., WASHINGTON, DC, 20036, US

(73) Assignee: General Dynamics Advanced, Fairfax, VA (US)

(21) Appl. No.: 11/783,714

(22) Filed: Apr. 11, 2007

Related U.S. Application Data
(60) Provisional application No. 60/790,799, filed on Apr. 11, 2006.

(51) Int. Cl. G02B 6/44; H02G 3/04

(52) U.S. Cl. 385/104; 174/97

(57) ABSTRACT

A cable and system for manufacturing the same is provided. The cable includes a core communications medium and an outer jacket surrounding the core communications medium. A plurality of grooves are in the outer surface of the outer jacket. Each of the grooves has a recess and an opening to access the recess, the recess having a larger width than the opening. Each of the plurality of conductors is exposed to the external environment and can be reached directly from the external environment.

### BACKGROUND OF THE INVENTION

1. Field of the Invention

The present invention relates to undersea cables. More specifically, the present invention relates to undersea cables with a helical grooved outer jacket that can support multiple conductors.

2. Discussion of Background Information

Commercially available undersea cables typically include a core cable, a protective cover around the cable, and a series of conductors (metal or fiber-optic) embedded in the cover that carry signals separate from the main core cable. One must cut into the protective cover to access these conductors, which places the underlying main core cable at risk of damage. Conductors can typically be placed near the surface of the protective cover to minimize the cut depth needed to access the conductors, which minimizes potential damage to the underlying main core cable. However, the reduction in thickness of the overlapping protective cover results in a corresponding loss of protection for the conductors.

### SUMMARY OF THE INVENTION

According to an embodiment of the invention, a cable is provided. The cable includes a core communications medium and an outer jacket surrounding the core communications medium. A plurality of grooves are in the outer surface of the outer jacket. Each of the grooves has a recess and an opening to access the recess, the recess having a larger width than the opening. Each of the plurality of conductors is exposed to the external environment and can be reached directly from the external environment.

The above embodiment may have various features. The outer jacket may include an extrusion grade, abrasion resistant polyether-based thermoplastic polyurethane with a durometer of between and including 74 to 85 Shore A; the outer jacket may include a lubricant mixed with polyurethane. The plurality of grooves may each have a substantially circular cross section. The core communications medium may be an unarmored fiber optic cable, either with or without its outer jacket.

According to another embodiment of the invention, a communications cable is provided. The cable includes a core communications medium and an outer jacket surrounding the core communications medium. A plurality of helical grooves are in the outer surface of the outer jacket. Each of the grooves has a recess and an opening to access the recess, the recess having a larger width than the opening. A communications cable is laid in each of the grooves. Each communications cable has a diameter less than or equal to a width of the recess, but greater than a width of the opening.

The above embodiment may have various features. The outer jacket may include an extrusion grade, abrasion resistant polyether-based thermoplastic polyurethane with a durometer of between and including 74 to 85 Shore A; the outer jacket may include a lubricant mixed with polyurethane. The plurality of grooves may each have a substantially circular cross section. The core communications medium may be an unarmored fiber optic cable, either with or without its outer jacket.

According to still another embodiment of the invention, a communications cable is provided. The cable includes a core communications medium and an outer jacket surrounding the core communications medium. The outer jacket at least partially including an extrusion grade, abrasion resistant polyether-based thermoplastic polyurethane with a durometer of between and including 74 to 85 Shore A. A plurality of helical grooves are in the outer surface of the outer jacket. Each of the grooves has a recess and an opening to access the recess, the recess having a substantially circular cross section and a diameter larger than the opening. A communications cable is laid in each of the grooves, each cable having a diameter less than or equal to the diameter of the recess, but greater than a width of the opening.

The above embodiment may have various features. The outer jacket may include an extrusion grade, abrasion resistant polyether-based thermoplastic polyurethane with a durometer of between and including 74 to 85 Shore A. The outer jacket may include a lubricant mixed with polyurethane. The plurality of,grooves may each have a substantially circular cross section. The core communications medium may be an unarmored fiber optic cable, either with or without its outer jacket. Each of the plurality of communications cables may be exposed to the external environment and can be accessed directly from the external environment.

According to yet another embodiment of the invention, a method for manufacturing a communications cable is provided. The steps include applying adhesive to a cable, preheating the cable and applied adhesive, passing the cable with adhesive through a die, the die being configured to form an outer jacket with grooves therein over the cable, rotating the die during the passing, extruding a compound around the cable with adhesive during the rotating, cooling the compound, cable and adhesive to form a cable with an outer jacket having grooves, and laying individual communication cables in the grooves.

The above embodiment may have various features. There may be an additional step of forming the compound by mixing a lubricant with an extrusion grade, abrasion resistant polyether-based thermoplastic polyurethane with a durometer of between and including 74 to 85 Shore A. There may be an additional step of winding the cable over a spool, which may precede or follow the step of laying.

According to yet another embodiment of the invention, a method for manufacturing a communications cable is provided. The method includes removing an outer layer of a cable, preheating the cable, passing the cable through a die, the die being configured to form an outer jacket with grooves therein over the cable, rotating the die during the passing, extruding a compound around the cable during the rotating, cooling the compound and cable to form a cable with an outer jacket having grooves, and laying individual communication cables in the grooves.

The above embodiment may have various features. There may be an additional step of forming the compound by mixing a lubricant with an extrusion grade, abrasion resistant polyether-based thermoplastic polyurethane with a durometer of between and including 74 to 85 Shore A. There may be an additional step of winding the cable over a spool, which may precede or follow the step of laying.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 illustrates a perspective view of a cable according to an embodiment of the invention;

FIG. 2 illustrates a side view of the outer jacket of the embodiment of FIG. 1 over a single pitch of the helicoid on the outer jacket;

FIG. 3 illustrates a cross section taken along line A-A in FIG. 2;

FIG. 4 illustrates the cross section of FIG. 3 with reference circles;

FIG. 5 illustrates a perspective view of a cable according to another embodiment of the invention;

FIG. 6 illustrates a side view of the outer jacket of the embodiment of FIG. 5 over single pitch of the helicoid on the outer jacket;

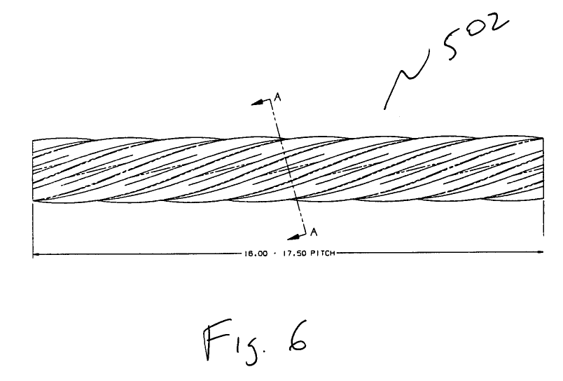

FIG. 7 illustrates a cross section taken along line A-A in FIG. 6; and

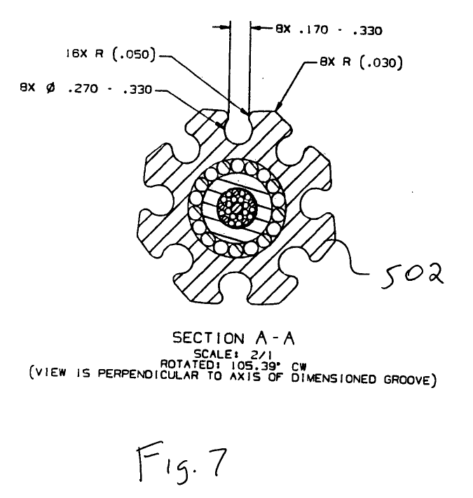

FIG. 8 illustrates an additional cross section view taken along line A-A in FIG. 6.

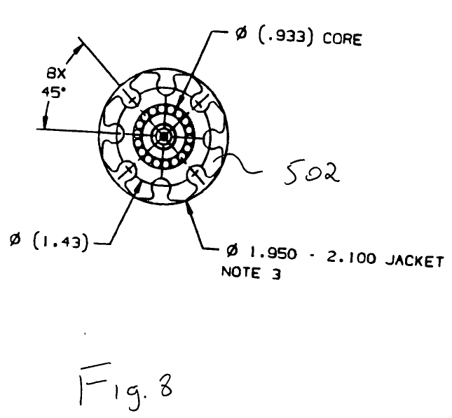

### DETAILED DESCRIPTION OF EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

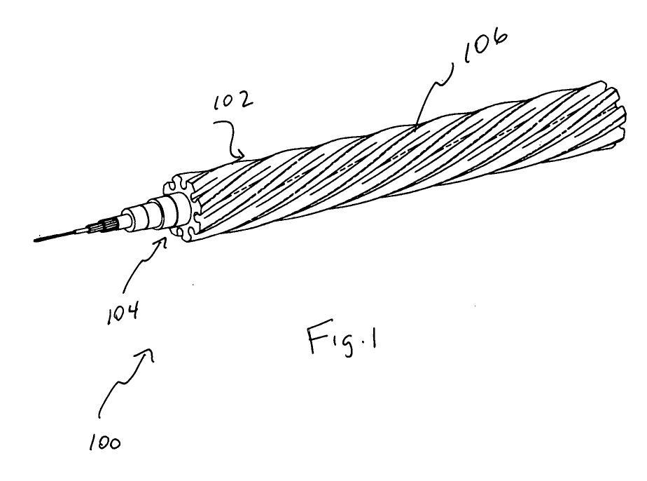

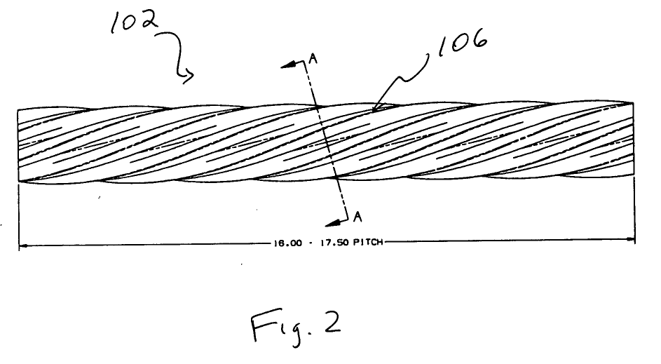

Referring to FIG. 1, an embodiment 100 includes an outer jacket 102 concentrically about a core cable 104. Cable 104 is preferably any commercially available unarmored cable used in undersea operations, although any commercially available cable could be used. Jacket 102 is preferably an extruded polyurethane structure which holds and protects cable 104 substantially coaxially therewith. Referring now also to FIG. 2, jacket 102 includes several equally spaced helical grooves 106 around its outer periphery. The grooves form a so-called “left hand lay,” which matches the lay of commercial undersea cables.

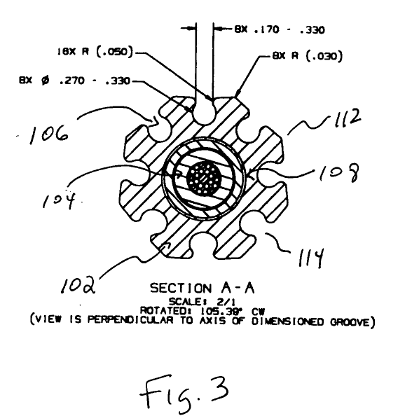

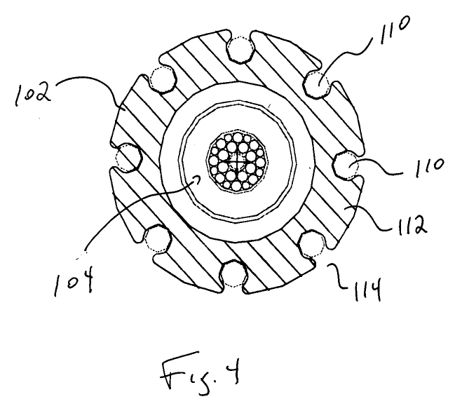

FIG. 3 shows a cross section of the embodiment 100 taken across line A-A in FIG. 2, which exposes the core cable 104 and the surrounding jacket 102. An adhesive layer 108 separates and joins cable 104 and jacket 102. FIG. 4 shows individual conductors 110 placed in each of grooves 106. The embodiments herein show eight grooves 106, but any number may be used.

Jacket 102 includes projections 112 that define each of the individual grooves 106. The groves are substantially circular in shape with an opening. 114 facing outward, although other non-circular shapes could be used. Opening 114 is preferably smaller than the diameter of conductors 110 so that conductors 110 will not fall out (absent intentional efforts to remove them), but wide enough such that conductors 110 can be popped into grooves 106 under the application of suitable external pressure. The inwardly facing edges of projections 112 adjacent opening 114 and the apex of projections 112 are preferably rounded to ease in cable insertion.

Jacket 102 provides protection for both core cable 104 and conductors 110. However, a technician can access individual conductors 110 simply by popping them right out of the groove 106. There is no need to cut into protective jacket 102, and thus no corresponding risk of damaging core cable 104.

The dimensions of embodiment 100 are highly dependent upon the nature of cable 104 and conductors 110. An unarmored commercial cable 104 typically has a diameter of 0.882 inches, and commercially available conductors 110 typically have a diameter of 0.260 inches. For cables and conductors of such dimensions, then embodiment 100 may have the following parameters:

Adhesive 108 is preferably approximately 0.03 inches thick, ±0.0075 inches. Since adhesive 108 surrounds cable 104, the diameter of cable 104 and adhesive 108 is preferably approximately 0.935±0.015 inches.

The distance between the outer diameter of adhesive 108 and the inner diameter of grooves 106 is preferably 0.195 inches, ±0.0375 inches.

The centers of each of conductors 110 preferably define a circle having a diameter of approximately 1.43 inches.

The outer diameter of jacket 102 is preferably 1.95-2.10 inches.

The diameter of the circular portion of groove 106 is preferably 0.270-0.330 inches.

The width of opening 114 is preferably 0.170-0.330 inches.

The edges of projections 112 adjacent opening 114 preferably have a radius of curvature of 0.050 inches.

The outermost edges of projections 112 preferably have a radius of curvature of 0.030 inches.

The length of a single turn (360° revolution) of one of grooves 106 is preferably 16-17.5 inches.

The minimum bend radius for embodiment 100 is preferably approximately 40 inches if the cable tension is less than 2000 lbs, and preferably approximately 60 inches if the cable tension is greater than or equal to 2000 lbs.

Jacket 102 is preferably made primarily from an extrusion grade, abrasion resistant polyether-based thermoplastic polyurethane with a durometer of between (and including) 74 to 85 Shore A. Below 74 would be sufficiently soft that it may not hold conductors 110 in place, whereas above 85 would be sufficiently hard that projections 112 would not bend under pressure to enlarge opening 114 to allow insertion of conductors 110. Elastolan 1175A1OW is suitable for this purpose, although other compounds may be used.

The jacket 102 compound includes polyurethane having the characteristics noted above and approximately 0.10%±0.05% lubricant. The lubricant will reduce the coefficient of sliding friction of the polyurethane during extrusion. Americhem 44192 is suitable for this purpose, although other compounds may be used.

The manufacturing process is as follows. Cable 104 is first fed into a system which applies adhesive 108 in an appropriate thickness. The cable 104 with adhesive 108 is then preheated to approximately 330-370 degrees F., particularly 350 degrees F., before being fed to a rotating die (not shown). The die has a cross section that substantially mirrors that shown in FIG. 3, modified as necessary to account for post-extrusion changes such as shrinkage. The polyurethane compound is extruded around cable 104 as it passes through the rotating die. Rotation of the die creates the helical exterior shape of jacket 102. Preferably approximately 1 foot of cable is extruded per minute. Jacket 102 is then cooled (under ambient temperature, fans, or other cooling systems) for approximately 1 hour before the finished product is wound on a spool.

Individual conductors 110 are preferably added at a later date, although they could also be added before the cable is wound; in either case, portions of conductors 110 are aligned with grooves 106 and subject to inward radial pressure to force the conductors 110 through opening 114 into grooves 106. This process repeats along with length of the cable.

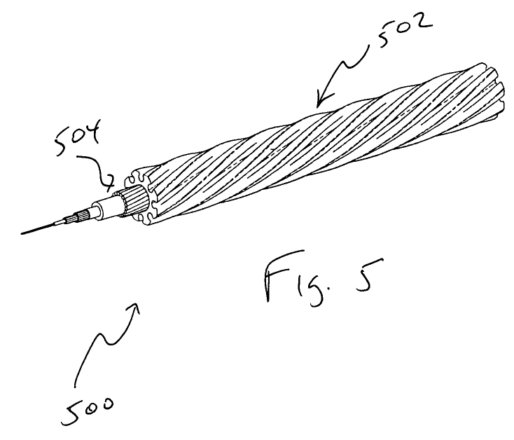

A perspective view of another embodiment 500 of the invention is shown in FIG. 5. A cable 504 is preferably a commercially available armored cable with its “tar and jute” (its outer nylon coating) removed, but other cables may be used. Since the polyurethane compound will easily bond with cable 504, no adhesive layer is necessary. A jacket 502 is identical to jacket 102 discussed above.

The dimensions of embodiment 500 are highly dependent upon the nature of cable 504 and conductors 110. An armored commercial cable 504 typically has a diameter of 0.933 inches, and commercially available conductors 110 typically have a diameter of 0.260 inches. Since the diameter of cable 504 is substantially equal to the diameter of cable 104 plus adhesive 108, then the dimensions of jacket 102 discussed above are equally applicable to jacket 502.

The manufacture of embodiment 500 is similar to embodiment 100. The steps of applying adhesive and heating are replaced with a step of removing the “tar and jute” outer coating of cable 504. The remainder of the manufacturing process is the same.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is:

1. A cable, comprising:
a core communications medium;
an outer jacket surrounding the core communications medium; and
a plurality of grooves in the outer surface of the outer jacket, each of said grooves having a recess and an opening to access said recess, said recess having a larger width than said opening;
wherein said each of said plurality of conductors is exposed to the external environment and can be reached directly from the external environment.

2. The cable of claim 1, wherein the outer jacket comprises an extrusion grade, abrasion resistant polyether-based thermoplastic polyurethane with a durometer of between and including 74 to 85 Shore A.

3. The cable of claim 1, wherein the outer jacket comprises a lubricant mixed with polyurethane.

4. The cable of claim 1, wherein said plurality of grooves each has a substantially circular cross section.

5. The cable of claim 1, wherein said core communications medium is an unarmored fiber optic cable.

6. The cable of claim 1, wherein said core communication medium is an unarmored fiber optic cable with its outer coating removed.

7. The cable of claim 1, further comprising a layer of adhesive between said core communications medium said outer jacket.

8. A communications cable, comprising:
a core communications medium;
an outer jacket surrounding the core communications medium;
a plurality of helical grooves in the outer surface of the outer jacket, each of said grooves having a recess and an opening to access said recess, said recess having a larger width than said opening; and
a communications cable laid in each of said grooves, each cable having a diameter less than or equal to a width of said recess, but greater than a width of said opening.

9. The cable of claim 9, wherein the outer jacket comprises an extrusion grade, abrasion resistant polyether-based thermoplastic polyurethane with a durometer of between and including 74 to 85 Shore A.

10. The cable of claim 9, wherein the outer jacket comprises a lubricant mixed with said polyurethane.

11. The cable of claim 8, wherein said plurality of grooves each has a substantially circular cross section.

12. The cable of claim 8, wherein said core communications medium is an unarmored fiber optic cable.

13. The cable of claim 8, wherein said core communication medium is an unarmored fiber optic cable with its outer coating removed.

14. The cable of claim 8, further comprising a layer of adhesive between said core communications medium said outer jacket.

15. A communications cable, comprising:
a core communications medium;
an outer jacket surrounding the core communications medium, said outer jacket at least partially including an extrusion grade, abrasion resistant polyether-based thermoplastic polyurethane with a durometer of between and including 74 to 85 Shore A;
a plurality of helical grooves in the outer surface of the outer jacket, each of said grooves having a recess and an opening to access said recess, said recess having a substantially circular cross section and a diameter larger than said opening;
a communications cable laid in each of said grooves, each cable having a diameter less than or equal to said diameter of said recess, but greater than a width of said opening.

16. The cable of claim 15, wherein said each of said plurality of communications cables are exposed to the external environment and can be accessed directly from the external environment.

17. The cable of claim 16, wherein the outer jacket comprises a lubricant mixed with said polyurethane.

18. The cable of claim 15, wherein said core communications medium is an unarmored fiber optic cable.

19. The cable of claim 15, wherein said core communications medium is an unarmored fiber optic cable with its outer coating removed.

20. The cable of claim 15, further comprising a layer of adhesive between said core communications medium said outer jacket.

21. A method for manufacturing a communications cable, comprising:
applying adhesive to a cable;
preheating the cable and applied adhesive;
passing said cable with adhesive through a die, the die being configured to form an outer jacket with grooves therein over said cable;
rotating said die during said passing;
extruding a compound around the cable with adhesive during said rotating;
cooling said compound, cable and adhesive to form a cable with an outer jacket having grooves; and
laying individual communication cables in said grooves.

22. The method of claim 21, further comprising forming said compound by mixing a lubricant with an extrusion grade, abrasion resistant polyether-based thermoplastic polyurethane with a durometer of between and including 74 to 85 Shore A.

23. The method of claim 21, further comprising winding said cable over a spool.

24. The method of claim 21, wherein said winding precedes said laying.

25. The method of claim 21, wherein said laying precedes said winding.

26. A method for manufacturing a communications cable, comprising:
removing an outer layer of a cable;
preheating the cable;
passing the cable through a die, the die being configured to form an outer jacket with grooves therein over said cable;
rotating said die during said passing;
extruding a compound around the cable during said rotating;
cooling said compound and cable to form a cable with an outer jacket having grooves; and
laying individual communication cables in said grooves.

27. The method of claim 26, further comprising forming said compound by mixing a lubricant with an extrusion grade, abrasion resistant polyether-based thermoplastic polyurethane with a durometer of between and including 74 to 85 Shore A.

28. The method of claim 26, further comprising winding said cable over a spool.

29. The method of claim 26, wherein said winding precedes said laying.

30. The method of claim 26, wherein said laying precedes said winding.
